(19) United States
(12) Patent Application Publication
(10) Pub. No.: US 2018/0108931 A1
(43) Pub. Date: Apr. 19, 2018

(54) VANADIUM REDOX FLOW BATTERIES

(71) Applicant: WattJoule Corporation, Devens, MA (US)

(72) Inventors: H. Frank Gibbard, Epping, NH (US); Reinder J. Boersma, Webster, MA (US)

(21) Appl. No.: 15/788,266

(22) Filed: Oct. 19, 2017

Related U.S. Application Data
(60) Provisional application No. 62/409,971, filed on Oct. 19, 2016.

(51) Int. Cl. H01M 8/18; H01M 4/90

(52) U.S. Cl. CPC H01M 8/188; C01G 31/02; H01M 4/9041

(57) ABSTRACT

A vanadium redox flow battery employs a single electrolyte as a starting material to be placed in equal amounts in the positive and negative electrolyte storage tanks for supporting electrolytes containing zinc and chloride ions. A supporting solution includes chloride ions and zinc ions, and a half-cell solution including vanadium ions based on an aggregate oxidation state around +3.5 is disposed in the supporting solution to form the electrolyte solution for the redox flow battery. With HCl as a supporting electrolyte, as an alternative to conventional sulfuric acid, the use of zinc provides multiple benefits in the preparation of vanadium-based electrolytes.

### RELATED APPLICATIONS

This application claims the benefit under 35 U.S.C. § 119(e) of U.S. Provisional Patent Application No. 62/409,971, filed Oct. 19, 2016, entitled “SUPPORTING ELECTROLYTES CONTAINING CHLORIDE AND ZINC IONS FOR VANADIUM REDOX FLOW BATTERIES,” incorporated herein by reference in entirety.

### BACKGROUND

The rapid growth of renewable energy sources, especially solar and wind power, has increased the demand for energy storage technologies to supplement those intermittent resources. Although electrochemical energy storage in batteries has been employed for this purpose, no commercially available battery satisfies all the needs of renewable energy supplementation, such as low installed and life-cycle cost; high reliability, safety, and efficiency; flexibility of design through separation of the attributes of power and energy; long cycle and calendar life; and wide operating temperature range without the need for active cooling means. Traditional rechargeable batteries such as lead-acid, nickel metal hydride and lithium ion comprise solid negative and positive electrode materials, and solid electrodes age and lose capacity due to the stresses they experience during the processes of charge and discharge.

The use of redox flow batteries, such as an early rendering of a titanium-chlorine system, avoids such stresses by the use of soluble active materials that are oxidized and reduced during cycling of the battery. The liquid electrolyte containing the active materials is circulated past or through the electrodes, which serve the purpose of electron exchange between the active materials and the electrical poles of the cell but experience no change in chemical identity or structure. Such batteries separate the characteristics of power and energy by storing the positive and negative electrolytes containing the chemical energy of the battery in tanks external to the cells. Thus, doubling the energy of a redox flow battery at constant power requires no change in the electrochemical cell, only the addition of more electrolyte in larger tanks. This flexibility of design is not available in traditional batteries, nor in hybrid flow batteries such as zinc halogen systems, in which one electrode solid stores active material in the interior of the cell.

During the early 1970's many redox flow battery systems were evaluated at NASA's Lewis Research Center; the most promising of these was chosen as the iron/chromium system, with the cell reaction for discharge of

Cr²⁺+Fe³⁺→Cr³⁺+Fe²⁺

Various problems have prevented the commercialization of this system. These include the management of side reactions, e.g., the tendency of the negative (chromium II/III) electrode to produce hydrogen gas during charge, and excessive osmotic transfer of water between the storage tanks. Additionally, the discovery of an unexpectedly high degree of purity of the active materials needed to operate the system substantially increased the cost of the system.

Several other redox flow battery systems have been evaluated for use in large-scale energy storage applications. For example, U.S. Pat. No. 4,786,567, entitled “All-Vanadium Redox Battery,” discloses the stability of four oxidation states of vanadium in acid solution, with the following electrodes comprising the soluble active redox species:

Negative electrolyte: V²⁺|V³⁺ with the standard reduction potential E°=−0.255 V

Positive electrolyte: V⁴⁺|V⁵⁺ with E°=−0.991 V

The electrochemical reactions at the two electrodes of the cell during charging of the battery are the following:

Negative electrode reaction: V³⁺+e⁻→V²⁺

Positive electrode: VO²⁺+H₂O→VO₂⁺+2H+e⁻

### SUMMARY

A vanadium redox flow battery employs a single electrolyte as a starting material to be placed in equal amounts in the positive and negative electrolyte storage tanks for supporting electrolytes containing zinc and chloride ions. A supporting solution includes chloride ions and zinc ions, and a half-cell solution including vanadium ions based on an aggregate oxidation state around +3.5 is disposed in the supporting solution to form the electrolyte solution for the redox flow battery. With HCl as a supporting electrolyte, as an alternative to conventional sulfuric acid, the use of zinc provides multiple benefits in the preparation of vanadium-based electrolytes.

A particular feature is that the electrolyte solution for use in the vanadium redox flow cell battery utilizes chloride ions and zinc ions as supporting electrolytes, and vanadium ions as electroactive materials. The same supporting electrolytes may be employed for both positive electrolyte (posilyte) and negative electrolyte (negalyte) fluid volumes (typically storage tanks). All of the four electrochemically active vanadium species are derived from a single vanadium material (V₂O₅). The use of zinc enables a range of thermal stability of the electrolyte from −20° C. to +70° C. and decreases the vapor pressure of HCl from the electrolyte over conventional approaches.

Conventional vanadium redox flow batteries exhibit the advantages of relatively high operating cell voltage of approximately 1.2 V, rapid electrode kinetics at each electrode, high conductivity of its 4 M sulfuric acid supporting electrolyte, moderate useful solubility of 1.6 M vanadium, and extended calendar and cycle life. In the case of electrical imbalance caused by cross-mixing of its electrolyte, the negative and positive electrolytes can be restored to full initial capacity by fully mixing them and then electrically charging the battery system. This advantage arises from the remarkable origin of all the active materials from a single common element: vanadium. These positive attributes have led to the construction and testing of many all-vanadium systems at the scale of hundreds of kilowatts and several megawatts.

Configurations herein are based, in part, on the observation that conventional battery cells employ a finite quantity of positive and negative charge material that limit the available charge capacity. Unfortunately, flow batteries, which employ a fluid electrolyte that dynamically replenishes the electric capacity based on available solution volume, suffer from the shortcomings of high cost, high temperature, and corrosiveness of flow solutions. Accordingly, configurations herein substantially overcome the above described shortcomings by teaching a flow battery electrolyte including V₂O₅ as the starting material and a process for the reduction to achieve an oxidation state of +3.5 for the starting electrolyte using zinc and zinc compounds.

Conventional approaches employing sulfuric acid electrolytes have drawbacks that have prevented widespread commercial use in grid-scale energy storage. A particular shortcoming is the relatively high cost of the total energy system, which is typically more than $1,000/kWh. Another important factor is the relatively narrow operating and storage temperature range of the system, typically only 10° C. to 35° C. Additionally, the energy storage capacity of the traditional all-vanadium system is relatively low owing to the only moderate useful concentration of the electrochemically active vanadium ions in the electrolyte, which typically does not exceed 1.6 moles of vanadium per liter of solution (1.6 M). Moreover, the processes that are typically used to manufacture the sulfuric-acid-based electrolyte may be both complex and expensive. Accordingly, the advantages of the disclosed approach include the following: reduce the cost of the DC energy storage system by a factor of four or more; extend the useful temperature range to −20° C. to 70° C.; increase the solubility of vanadium in the electrolyte to at least 2.0 M; and simplify the manufacturing process of the electrolyte to include only one vanadium-containing starting material and one acid component.

A particular conventional approach, as shown in U.S. Pat. No. 8,628,880, teaches that the addition of hydrochloric acid to the sulfuric acid supporting electrolyte of the all-vanadium system increases the solubility of vanadium in the electrolyte to 2.5 mol/L and increases the temperature range of this system to −5 to +60° C. The '880 patent, however, does not address the major issues of system cost and provision of a simple method for electrolyte manufacture that promotes the low system cost needed to achieve widespread commercialization of the all-vanadium redox flow system. Thus, the following discussion will show how the disclosed configurations achieve each of the objectives mentioned above and presents examples of specific embodiments of the invention.

Configurations disclosed herein address the problem of preparing a single electrolyte that serves as the starting material to be placed in equal amounts in the positive and negative electrolyte storage tanks. The oxidation state of this initial electrolyte should be substantially around +3.5, which means that it will be an equimolar mixture of V³⁺ and V⁴⁺. Thus, the quantity of electricity per mole of V on the first charge should be 1.5 moles of electrons, i.e., 1.5 Faradays, for each half-cell reaction, as the positive active material loses this amount (oxidation number +3.5→+5.0) and the negative active material receives this amount (oxidation number +3.5→+2.0). In addition to the property of a single oxidation state for the electrolyte, a vanadium concentration of at least 2 M and preferably 2.5 M or 2.75 M is beneficial. A total concentration of vanadium is typically in a range between 0.5 M and 3.0 M, as less does not provide sufficient charge capacity and greater concentrations may be prone to precipitation.

Configurations herein address a problem for performing dissolution of a mixture of vanadium oxides in the proportions of three moles of V₂O₃ to each mole of V₂O₅ in an aqueous acid solution, which would yield the desired average oxidation number of 3.5 for the vanadium in the starting electrolyte. For example, to prepare one liter of starting electrolyte with a total vanadium concentration of 2.0 M would require the dissolution of 112.41 g of V₂O₃ and 45.47 g of V₂O₅ in an acidic solution, to form 1.0 L of electrolyte. Laboratory experiments to carry out this method were found to have several difficulties relating to the use of the trivalent oxide. Not only was the V₂O₃ found to be only sparingly soluble in both hydrochloric and sulfuric acids, but the V₂O₃ available from several vendors was found to be contaminated with other oxides (e.g., V₄₀₉) and black, insoluble particles identified as carbon residue from the manufacturing process used to make V₂O₃ by reduction of V₂O₅. Furthermore, the trivalent oxide was found to be considerably more expensive than the pentavalent oxide, per mole of vanadium, owing to the extra manufacturing steps required for the synthesis of the former.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a flowchart of electrolyte preparation in a vanadium flow battery as disclosed herein;

FIG. 2 shows cycling data for a flow battery using the electrolyte of FIG. 1;

FIG. 3 shows highly stable coulombic, voltaic and round-trip efficiencies for the cycling of a particular configuration of the electrolyte;

FIG. 4 shows the stable results for coulombic (Ah/L) capacity and energy (Wh/L) capacity of the 2.5 M electrolyte's coulombic, voltaic and round-trip efficiencies for the cycling of the electrolyte of Example 3;

FIG. 5 shows the high and stable electrical efficiency of 80% enabled by coulombic and voltaic efficiencies of 96% and 83%, respectively; and

FIG. 6 shows voltage, current and flow for a zinc chloride configuration of the flow battery of FIGS. 1-5.

### DETAILED DESCRIPTION

The disclosed approach teaches an electrolyte solution for use in a vanadium redox flow cell battery including a supporting solution having chloride ions and zinc ions and a positive half-cell solution including V⁴⁺ ions and V⁵⁺ ions. In the disclosed vanadium redox flow cell battery, a half-cell solution is disposed in the supporting solution to form the electrolyte solution. The negative half-cell solution in this approach employs a solution including V²⁺ ions and V³⁺ ions.

A method for generating an electrolyte for a redox flow battery as disclosed herein include depositing a known weight of V₂O₅ into a preparation vessel, and mixing aqueous hydrochloric acid into the preparation vessel to form a slurry. An organic reducing agent, such as powdered oxalic acid, is added to the to the slurry, and mixed until dissolution of the V₂O₅. After a cooling period, a zinc based substance is added and agitated until dissolution. The added zinc based substance includes powdered zinc aliquots and/or zinc chloride.

The disclosed approach commences with electrolyte and supporting solution preparation having an initial state, followed by cyclic oxidation states when the flow cell is cycled. Thus, the electrolytes made for the posilyte and negalyte may not initially be those that will be present when the cell is cycled. For example, an initial battery electrolyte solution includes electrolyte that is either in the +3.5 oxidation state, or the +4.0 state, however may not persist as the electrolyte in a cycling cell. The posilyte employs vanadium in a +5 and +4 oxidation states, not necessarily the actual ionic species present, which may be, respectively, VO₂⁺ and VO²⁺. Similarly, the negalyte employs V²⁺ and V³⁺ electroactive ions wherein the symbols 2+ and 3+ designate the oxidation states of vanadium in the ionic species present in the solution.

In the configurations depicted below, V₂O₅ was chosen as the vanadium-containing starting material, based on the desirable properties of lowest cost and high purity (minimum of 99.6% purity) for the available commercial material. Yet another simplification of the electrolyte preparation process provides that only one acid be employed in the electrolyte synthesis. Sulfuric acid is a less-than-optimal choice for this purpose owing to the poor stability of all-sulfuric-acid vanadium electrolytes at both high and low temperatures. Because of the high solubility of chloride salts, HCl is preferable as the single acid to be employed in the electrolyte.

With the choice of V₂O₅ as the starting material, a process for the reduction of this pentavalent material was required in order to prepare the chosen oxidation state of +3.5 for the starting electrolyte. Both oxalic acid and glycerol were found suitable to reduce the V⁵⁺ to the V⁴⁺ state, with carbon dioxide and water as reaction products, but neither may be a strong enough reducing agent to complete the reduction process to V^{3.5+}. Reduction processes based on metallic zinc were carried out because of its strong reducing power, low cost, and high purity. With HCl as a supporting electrolyte, the use of zinc was found to have several benefits in the preparation of vanadium-based electrolytes. In particular configurations, the formed electrolyte solution includes an equimolar mixture of V³⁺ and V⁴⁺ ions, and the electrolyte solution has an initial oxidation state substantially around +3.5. The resulting flow battery is such that the electrolyte is responsive to a positive active material for losing electrons to achieve an oxidation state of 5.0, and the electrolyte is responsive to a negative active material for gaining electrons to achieve an oxidation state of +2.0. It should be noted that, for the +4 and +5 oxidation states of vanadium, the actual ionic species contain either one or two atoms of oxygen, to that their actual charges are only +1 and +2.

Prior to operating as a charge/discharge cell, the formed electrolyte achieves an initial oxidation state that it is unlikely to return following charge cycles. This electrolyte solution employs V⁴⁺ as an electroactive species prior to charging or discharging, and species of vanadium other than V⁴⁺ are excluded from the electrolyte solution. In other words, the electrolyte solution initially formed from V₂O₅ is mixed with reducing agents such that all vanadium is reduced to V⁴⁺. In particular configurations, the electrolyte solution is obtained by the reduction of V⁵⁺ by oxalic acid or glycerol. Prior to cycling of the battery, the electrolyte solution is initially formed based on an equimolar mixture of V³⁺ and V⁴⁺ ions. Thus, the electrolyte solution has an initial oxidation state substantially around +3.5.

From an initial solution formed from V₂O₅ (typically formed using an HCl solution), the oxidation state is reduced to 4+ via reducing agents, and further to 3.5+ by predetermined quantities of zinc, or by electrochemical (charging) activity, followed by the addition of zinc chloride, as discussed in the following examples. Therefore, the oxidation state of 3.5+ results from zinc metal as a reducing agent, or from the charging of a battery cell containing the electrolyte in both the positive and negative tanks, accompanied by reduction of the posilyte by the use of glycerol or oxalic acid.

The narrow operating temperature range of the all-vanadium redox flow battery with sulfuric acid supporting electrolyte has been mentioned above. This has been found in several conventional approaches to be caused by the precipitation of V²⁺ species below −5° C. and V⁺⁵ species above 40° C. In contrast, electrolytes of the claimed approach have been found to be stable for more than 90 days at temperatures down to −20° C. and up to 70° C., over the range of oxidation states from slightly higher than V²⁺ to slightly lower than V⁵⁺, that is, the entire range encountered during charge and discharge of the all-vanadium redox flow cell.

The use of zinc as a reducing agent provides an additional improvement to the properties of the electrolyte. This is related to its function in lowering the vapor pressure of HCl gas above the electrolyte solution. The zinc may be any suitable form, but in particular configurations is selected from the group consisting of solid zinc metal and zinc chloride. When zinc and chloride ions are both present in an aqueous solution, a series of complexation reactions occurs, as shown in the following equations, with the corresponding association constant βᵢ for the ith reaction:

Zn²⁺+Cl⁻□ZnCl⁺ βᵢ=[ZnCl⁺]/[Zn²⁺][Cl⁻]

ZnCl⁺+Cl⁻□ZnCl₂ β₂=[ZnCl₂]/[ZnCl⁺][Cl⁻]

ZnCl₂+Cl⁻□ZnCl₃⁻ β₃=ZnCl₃⁻/[ZnCl₂][Cl⁻]

ZnCl₃+Cl⁻□ZnCl₄²⁻ β₄=ZnCl₄²⁻/[ZnCl₃⁻][Cl⁻]

The net result of this series of reactions is that the amount of free chloride ion present in the solution is reduced by their being bound in zinc chloro-complexes. The presence of zinc in the electrolyte results either from a reduction reaction using zinc metal, or through the addition of a zinc compound to a solution containing hydrochloric acid as a supporting electrolyte, where it dissolves without serving as a reducing agent. Alternative preparations can be chosen to yield the same zinc concentration in the electrolyte. The removal of free chloride ions from the solution in turn decreases the thermodynamic activity of HCl, expressed as:

a_{HCl}=m_{H}_{⁺}m_{Cl}_{^{−}}γ_{±}²

In which m denotes the molality of an ionic species, and γ_{±}² is the square of the mean ionic activity coefficient of the hydrogen and chloride ions. For the change in state

HCl(aq)→HCl(v)

that is, for the vaporization of aqueous HCl dissolved in the electrolyte, the equilibrium vapor pressure of HCl is decreased by a decrease in the activity of HCl(aq). Thus the addition of zinc ions to the aqueous electrolyte has the benefit of lowering the concentration of corrosive HCl vapor in the void space above both the posilyte and the negalyte in the redox flow battery.

An additional benefit of the presence of zinc ions in the electrolyte is that at a concentration of at least 0.5 M, the range of thermal stability of electrolyte is extended from −10 to +35° C. up to −20 to 70° C. The range of thermal stability is the span of temperature over which no precipitation of any solid material occurs within the electrochemical cell during its operation. Therefore, a concentration of zinc ions is at least 0.5M and results in a precipitation-free thermal stability range between −20° C. and 70° C. Such a wide operating temperature range eliminates the need for active cooling of the electrolyte during charge and discharge, which saves capital cost of the equipment and increases the efficiency of the battery system.

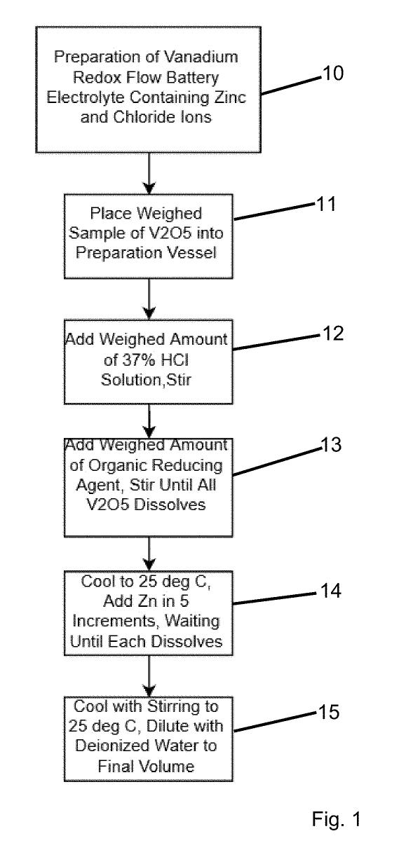

The preparation of electrolyte of the claimed approach is achievable in simple one-pot synthesis 10, as shown in the flow diagram in FIG. 1. Referring to FIG. 1, in this synthesis, a known weight of V₂O₅ is added to the preparation vessel, as depicted at step 11, and a known quantity of aqueous hydrochloric acid is added at step 12, and the slurry is stirred for a short period of time, typically 10-15 minutes. Then a known weight of an organic reducing agent is added, as depicted at step 13, and the mixture is stirred until all of the V₂O₅ has dissolved. During this dissolution, the temperature of the mixture rises from room temperature to a typical temperature of 60-70° C. The electrolyte is allowed to cool nearly to room temperature, and aliquots of zinc powder are added to the stirred electrolyte, typically in 4-6 equal additions, until each aliquot of zinc has dissolved, as disclosed at step 14. This process is also exothermic, and the final temperature is typically approximately 70° C. The solution is then allowed to cool with stirring for several hours, as shown at step 15. Finally, the state of oxidation is measured by an electrometric titration to verify the completion of the desired electrolyte composition. Significantly, no electrochemical processing is required in this electrolyte preparation process, which has been shown to be scalable to volumes of thousands of liters per batch.

Various configurations and use cases of the disclosed approach are discussed in the examples below.

Example 1 shows electrolyte preparation using oxalic acid and zinc, followed by demonstration of use in vanadium redox battery cell. The objective of this example was to prepare 1.0 L of electrolyte with the following composition:

[V]=2.0 M; [V³⁺]=[V⁴⁺]=1.0M; oxidation state=+3.5

[Cl⁻]=10.0 M

[H⁺]=4.0 M

[Zn²⁺]=0.5 M

Following the procedure on FIG. 1, 181.9 g of 99.6% pure V₂O₅ was added to a 1 L Erlenmeyer flask, and 985.4 g of 37% aqueous HCl (ACS reagent grade) was added. With the use of a Teflon-coated magnetic stirrer, the solution was stirred for 15 minutes, forming a red-brown slurry of V₂O₅. With continued stirring, a quantity of 90.0 g of powdered oxalic acid was added and stirred until all of the V₂O₅ was dissolved (an exothermic process), and the temperature had decreased back to within about 5° C. of room temperature. Then a quantity of 8.17 g of 99.9% pure zinc shot was added to the stirred mixture. Each time the temperature began to fall after a rise of several degrees C., another amount of zinc was added until 32.69 g of zinc had been added. The solution was then allowed to stir overnight, then filtered through a 5-micron paper filter, then diluted with distilled water to exactly 1.000 L in a volumetric flask at lab temperature of approximately 23° C. A quantity of 1.00 mL of the solution was diluted to 100 mL and titrated with 0.1 N (0.02 M) potassium permanganate using a Hanna automatic redox titrator. This titration confirmed the vanadium concentration at 2 M and the oxidation state of the vanadium within the range of 3.5-3.7.

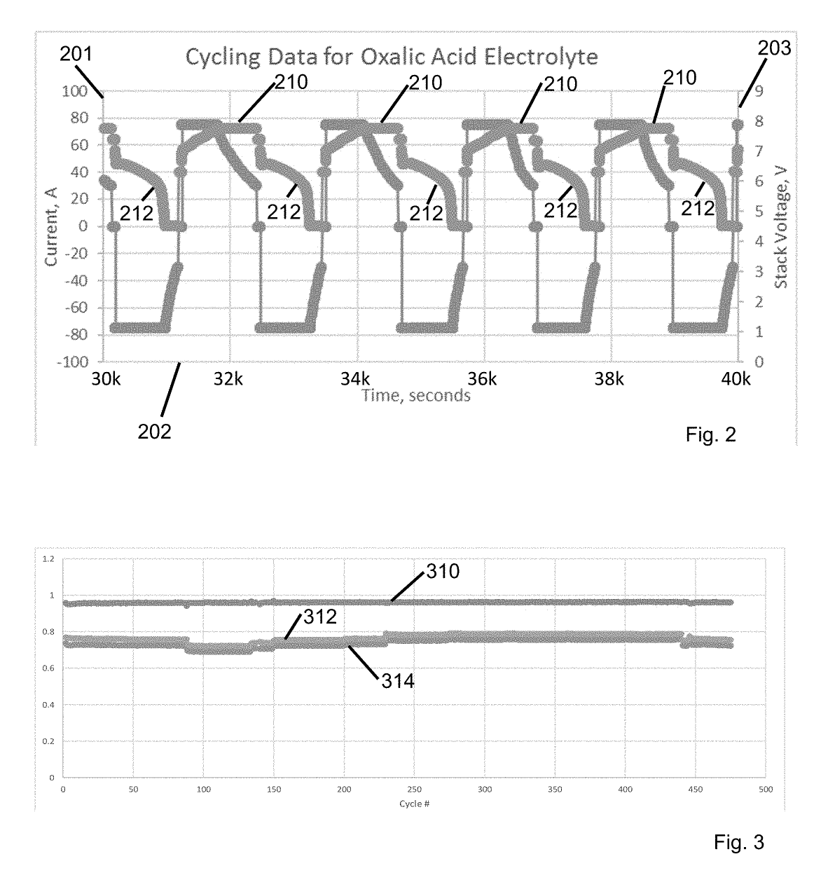

Cycling data for this electrolyte is shown in FIG. 2. The cell stack contained five 250-cm² cells and was cycled at a charge current of 75 A, shown on axis 201 (a current density of 300 mA/cm²) until the cell voltage reached 1.55 V/cell, shown at plateau 210; the charge voltage was then clamped at 1.55 V/cell until the current declined to 30 A, shown at 212. At that point the cell was given one minute of rest, shown on time axis 202. Then the cell was discharged at 75 A until the cell voltage declined to 0.9 V, shown on axis 203, after one minute of rest the charge resumed at 75 A for the next cycle. The performance of this combination of cell stack and electrolyte was tested for 300 cycles, with stable performance of 96 percent Coulombic efficiency, 78-83 percent voltaic efficiency, and 75-80 percent round-trip efficiency.

When charging, the positive electrolyte solution is responsive to a charge current in a battery cell by losing electrons to achieve an oxidation state up to +5.0. Similarly, the negative electrolyte is responsive to a charge current in a battery cell by gaining electrons to achieve an oxidation state of down to +2.0 during a charging scenario.

Example 2 depicts preparation of 2.0 M electrolyte using glycerol and zinc, followed by demonstration of use in vanadium redox battery cell. The objective of this example was to prepare electrolyte of the same composition of Example 1, but with the first reduction step carried out by the addition of glycerol rather than oxalic acid. The motivation for this experiment is to evaluate the use of glycerol, a much less expensive alternative to oxalic acid, for production of vanadium redox battery electrolyte. Following the procedure of FIG. 1, 181.9 g of 99.6% pure V₂O₅ was added to a 1-L Erlenmeyer flask, and 985.4 g of 37% aqueous HCl (ACS reagent grade) was added. With the use of a Teflon-coated magnetic stirrer, the solution was stirred for 15 minutes, forming a red-brown slurry of V₂O₅. With continued stirring, a quantity of 15.3 g of liquid glycerol (ACS reagent grade) was added and stirred until all of the V₂O₅ was dissolved in an exothermic process. In contrast to the procedure of Example 1, it was found that the reduction process was more effective if the mixture was heated to approximately 65° C. and held at that temperature for several hours with stirring. When the slurry had completely dissolved to form a homogeneous solution, external heating was terminated, and stirring was continued. When the temperature had decreased back to within about 5° C. of room temperature, a quantity of 8.17 g of 99.9% pure zinc shot was added to the stirred mixture. Each time the temperature began to fall after a rise of several degrees C., another amount of zinc was added until 32.69 g of zinc had been added. The solution was then allowed to stir overnight, then filtered through a 5-micron paper filter, then diluted with distilled water to exactly 1.000 L in a volumetric flask at lab temperature of approximately 23° C. A quantity of 1.00 mL of the solution was diluted to 100 mL and titrated with 0.1 N (0.02 M) potassium permanganate using a Hanna automatic redox titrator. This titration confirmed the vanadium concentration at 2 M and the oxidation state of the vanadium within the range of 3.5-3.7.

FIG. 3 shows the highly stable coulombic (charge 310), voltaic (voltage 312) and round-trip (energy 314) efficiencies for the cycling of the electrolyte of Example 2 for 475 cycles.

Example 3 depicts preparation of 2.5 M electrolyte using glycerol and zinc, followed by demonstration of use in a vanadium redox battery cell. The objective of this example was to prepare electrolyte by the same process of Example 2, but with the concentration of vanadium increased to 2.5 M. The motivation for this experiment is to demonstrate a more energy-dense electrolyte that has the possibility of decreasing system size and lowering its cost. Following the procedure of FIG. 1, 227.5 g of 99.6% pure V₂O₅ was added to a 1-L Erlenmeyer flask, and 985.4 g of 37% aqueous HCl (ACS reagent grade) was added. With the use of a Teflon-coated magnetic stirrer, the solution was stirred for 15 minutes, forming a red-brown slurry of V₂O₅. With continued stirring, a quantity of 19.1 g of liquid glycerol (ACS reagent grade) was added and stirred until all of the V₂O₅ was dissolved in an exothermic process. In contrast to the procedure of Example 1, it was found that the reduction process was more effective if the mixture was heated to approximately 65° C. and held at that temperature for several hours with stirring. When the slurry had completely dissolved to form a homogeneous solution, external heating was terminated, and stirring was continued. When the temperature had decreased back to within about 5° C. of room temperature, a quantity of 10.21 g of 99.9% pure zinc shot was added to the stirred mixture. Each time the temperature began to fall after a rise of several degrees C., another amount of zinc was added until 40.85 g of zinc had been added. The solution was then allowed to stir overnight, then filtered through a 5-micron paper filter, then diluted with distilled water to exactly 1.000 L in a volumetric flask at lab temperature of approximately 23° C. A quantity of 1.00 mL of the solution was diluted to 100 mL and titrated with 0.1 N (0.02 M) potassium permanganate using a Hanna automatic redox titrator. This titration confirmed the vanadium concentration at 2.5 M and the oxidation state of the vanadium within the range of 3.5-3.7.

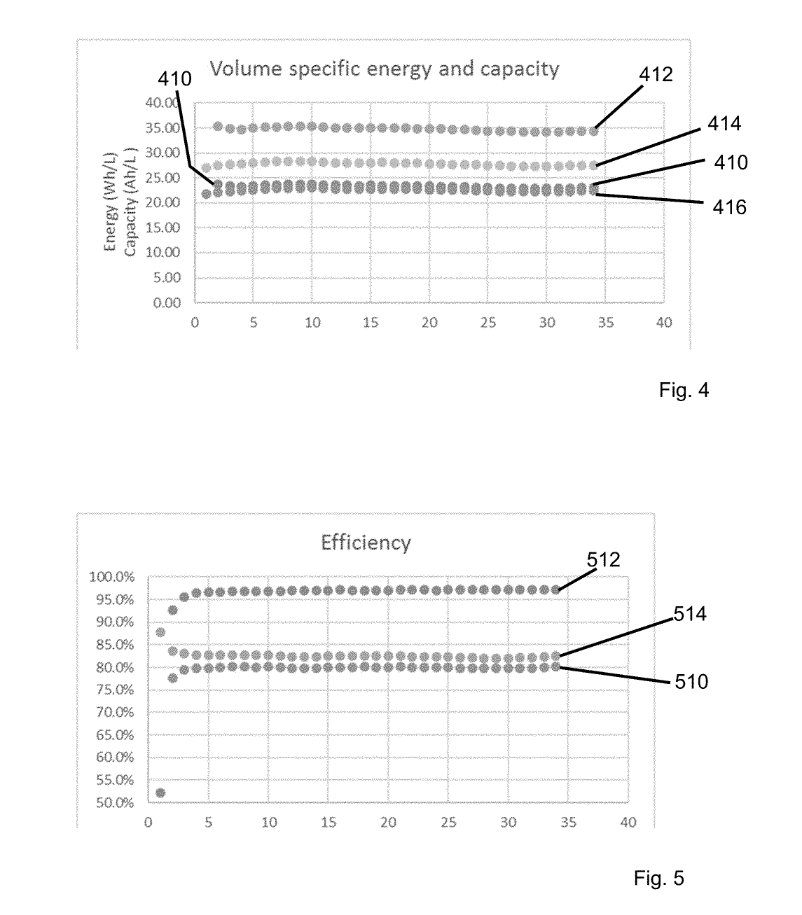

FIG. 4 shows the stable results for coulombic (Ah/L) capacity and energy (Wh/L) capacity of the 2.5 M electrolyte's coulombic, voltaic and round-trip efficiencies for the cycling of the electrolyte of Example 3 during early cycling. Referring to FIG. 4, charge capacity Ah/L 410, charge energy Wh/L 412, discharge energy Wh/L 414 and discharge capacity Ah/L are shown. The single cell had an active electrode area of 250 cm2, with an electrolyte volume of 1.4 L each for the posilyte and anolyte tanks. The oxidation state of each electrolyte at the beginning of cycling was 3.51. FIG. 5 shows the high and stable electrical efficiency of 80% 510 enabled by coulombic 512 and voltaic 514 efficiencies of 96% and 83%, respectively.

Example 4 shows preparation of 2.75 M electrolyte using glycerol and zinc, followed by demonstration of use in vanadium redox battery cell. The objective of this example was to prepare electrolyte by the same process of Examples 2 and 3, but with the concentration of vanadium increased to 2.75 M. The motivation for this experiment is to extend the demonstration of a more energy-dense electrolyte that has the possibility of decreasing system size and lowering its cost. Following the procedure of FIG. 1, 250.2 g of 99.6% pure V₂O₅ was added to a 1-L Erlenmeyer flask, and 1059.3 g of 37% aqueous HCl (ACS reagent grade) was added. With the use of a Teflon-coated magnetic stirrer, the solution was stirred for 15 minutes, forming a red-brown slurry of V₂O₅. With continued stirring, a quantity of 21.0 g of liquid glycerol (ACS reagent grade) was added and stirred until all of the V₂O₅ was dissolved in an exothermic process. As in Example 3, the mixture was heated to approximately 65° C. and held at that temperature for several hours with stirring. When the slurry had completely dissolved to form a homogeneous solution, external heating was terminated, and stirring was continued. When the temperature had decreased to within about 5° C. of room temperature, a quantity of 11.24 g of 99.9% pure zinc shot was added to the stirred mixture. Each time the temperature began to fall after a rise of several degrees C., another amount of zinc was added until 44.95 g of zinc had been added. The solution was then allowed to stir overnight, then filtered through a 5-micron paper filter, then diluted with distilled water to exactly 1.000 L in a volumetric flask at lab temperature of approximately 23° C. A quantity of 1.00 mL of the solution was diluted to 100 mL and titrated with 0.1 N (0.02 M) potassium permanganate using a Hanna automatic redox titrator. This titration confirmed the vanadium concentration at 2.75 M and the oxidation state of the vanadium within the range of 3.5-3.7.

Preliminary testing of the 2.75 M electrolyte was carried out in a small laboratory cell with 25-cm² electrodes, maintained in a laboratory constant-temperature oven at 45° C. Each electrolyte vessel was a 125-mL Erlenmeyer flask containing 50 mL of electrolyte. Average efficiencies for cycling of the cell were 97%, 83% and 80% for the coulombic, voltaic and round-trip electrical efficiency, respectively.

The disclosed approach provides distinct advantages for thermal stability and avoiding precipitation of the electrolyte. In early, conventional all-vanadium redox flow batteries, it was discovered that storage of cells that contained only sulfuric acid as a supporting electrolyte, outside a limited temperature range of about 10-35° C., would result in the precipitation of solids containing vanadium. This precipitation caused severe deterioration, and in some cases, total failure of systems, due to stoppage of the flow of electrolyte through the cell stack. Since a wide range of ambient temperature and internal operating temperature of the battery is highly desirable to avoid energy losses associated with active heating or cooling of the system, a large range of stable operating temperature is needed. An important and unexpected result of the presence of zinc ions in the electrolyte of the present invention is an extremely wide range of storage and operating temperatures that it enables.

Tables 1-3 show the large range of thermal stability of the electrolyte, from −20° C. to 70° C., as well as a wide range of vanadium concentrations, from 2 M to 2.75 M. The Time Stable column refers only to the length of time that was available for testing. In no case was precipitation found in these studies.

TABLE I
Table 1. Stability of vanadium-chloride-zinc solutions
Total [V] = 2M; Total [Cl⁻] = 10M; [Zn²⁺] = 0.5M

| | | | | Charge |
|---|---|---|---|---|
| Vⁿ⁺, M | V^{m+}, M | T, ° C. | Time Stable | State |
| V3+ = 1 Mol/L | V4+ = 1 Mol/L | 70 | 180 days | uncharged |
| V2+ = 0.3 Mol/L | V3+ = 1.7 Mol/L | 70 | 30 days | discharged |
| | | | | negalyte |
| V2+ = 1.7 Mol/L | V3+ = 0.3 Mol/L | 70 | 30 days | charged |
| | | | | negalyte |
| V4+ = 0.3 Mol/L | V5+ = 1.7 Mol/L | 70 | 30 days | charged |
| | | | | posilyte |
| V4+ = 1.7 Mol/L | V5+ = 0.3 Mol/L | 70 | 30 days | discharged |
| | | | | posilyte |
| V3+ = 1 Mol/L | V4+ = 1 Mol/L | −20 | 180 days | uncharged |
| V2+ = 0.3 Mol/L | V3+ = 1.7 Mol/L | −20 | 30 days | discharged |
| | | | | negalyte |
| V2+ = 1.7 Mol/L | V3+ = 0.3 Mol/L | −20 | 30 days | charged |
| | | | | negalyte |
| V4+ = 0.3 Mol/L | V5+ = 1.7 Mol/L | −20 | 30 days | charged |
| | | | | posilyte |
| V4+ = 1.7 Mol/L | V5+ = 0.3 Mol/L | −20 | 30 days | discharged |
| | | | | posilyte |

TABLE II
Table 2. Stability of vanadium-chloride-zinc solutions
Total [V] = 2.5M; Total [Cl⁻] = 11.5M; [Zn²⁺] = 0.625M

| Vⁿ⁺, M | V^{m+}, M | T, ° C. | Time Stable | Charge State |
|---|---|---|---|---|
| V3+ = 1.25 Mol/L | V4+ = 1.25 Mol/L | 70 | 180 days | uncharged |
| V2+ = 0.375 Mol/L | V3+ = 2.125 Mol/L | 70 | 30 days | discharged negalyte |
| V2+ = 2.125 Mol/L | 0.375 Mol/L | 70 | 30 days | charged negalyte |
| V4+ = 0.375 Mol/L | V5+ = 2.125 Mol/L | 70 | 30 days | charged posilyte |
| V4+ = 2.125 Mol/L | V5+ = 0.375 Mol/L | 70 | 30 days | discharged posilyte |
| V3+ = 1.25 Mol/L | V4+ = 1.25 Mol/L | −20 | 180 days | uncharged |
| V2+ = 0.375 Mol/L | V3+ = 2.125 Mol/L | −20 | 30 days | discharged negalyte |
| V2+ = 2.125 Mol/L | V3+ = 0.375 Mol/L | −20 | 30 days | charged negalyte |
| V4+ = 0.375 Mol/L | V5+ = 2.1215 Mol/L | −20 | 30 days | charged posilyte |
| V4+ = 2.125 Mol/L | V5+ = 0.375 Mol/L | −20 | 30 days | discharged posilyte |

TABLE III
Table 3. Stability of vanadium-chloride-zinc solutions
Total [V] = 2.75M; Total [Cl⁻] = 10.75M; [Zn²⁺] = 0.6875M

| Vⁿ⁺, M | V^{m+}, M | T, ° C. | Time Stable | Charge State |
|---|---|---|---|---|
| V3+ = 1.375 Mol/L | V4+ = 1.375 Mol/L | 70 | 14 Days | uncharged |
| V2+ = 0.4125 Mol/L | V3+ = 2.3375 Mol/L | 70 | 14 Days | discharged negalyte |
| V2+ = 2.3375 Mol/L | V3+ = 0.4125 Mol/L | 70 | 14 Days | charged negalyte |
| V4+ = 0.4125 Mol/L | V5+ = 2.3375 Mol/L | 70 | 14 Days | charged posilyte |
| V4+ = 2.3375 Mol/L | V5+ = 0.4125 Mol/L | 70 | 14 Days | discharged posilyte |
| V3+ = 1.375 Mol/L | V4+ = 1.375 Mol/L | −20 | 14 Days | uncharged |
| V2+ = 0.4125 Mol/L | V3+ = 2.3375 Mol/L | −20 | 14 Days | discharged negalyte |
| V2+ = 2.3375 Mol/L | V3+ = 0.4125 Mol/L | −20 | 14 Days | charged negalyte |
| V4+ = 0.4125 Mol/L | V5+ = 2.3375 Mol/L | −20 | 14 Days | charged posilyte |
| V4+ = 2.3375 Mol/L | V5+ = 0.4125 Mol/L | −20 | 14 Days | discharged posilyte |

Example 5 shows preparation of 2.0 M electrolyte using glycerol and zinc chloride, followed by demonstration of use in vanadium redox battery cell. The objective of this example was to demonstrate a method of preparing electrolyte by the addition of a salt of zinc, in this case zinc chloride, in place of the addition to the electrolyte of zinc metal shown in other examples. This method provides zinc as a complexing agent for chloride ion in the electrolyte and may be preferred for the preparation of commercial quantities of large quantities of redox flow battery electrolytes. In this embodiment of the invention, 727.6 g of 99.6% pure V₂O₅ and 545.2 g of anhydrous ZnCl₂ (Sigma Aldrich reagent grade) was added to a 6-L Erlenmeyer flask, and 3548 g of 37% aqueous HCl (ACS reagent grade) was added. With the use of a Teflon-coated magnetic stirrer, the mixture was stirred for 15 minutes, forming a red-brown slurry of V₂O₅ and dissolved ZnCl₂. With continued stirring, a quantity of 61.2 g of liquid glycerol (ACS reagent grade) was added and stirred until all of the V₂O₅ was dissolved in an exothermic process. When the slurry had completely dissolved to form a homogeneous solution, stirring was continued until the temperature of the solution had fallen to 25°. The solution was then diluted to 4.0 L with deionized water and mixed thoroughly to ensure homogeneity, then filtered through a 5-micron paper filter at 25° C. A quantity of 1.00 mL of the solution was diluted to 100 mL and titrated with 0.1 N (0.02 M) potassium permanganate using a Hanna automatic redox titrator. This titration confirmed the vanadium concentration at 2.0 M and the oxidation state of the vanadium of +4.0.

The following procedure was used to convert the electrolyte from the oxidation of 4.0 to the desired value of 3.5. A quantity of 4.0 L of electrolyte was divided into two equal portions of 2.0 L, and the two portions were added to the posilyte and negalyte storage tanks of a small vanadium redox flow battery.

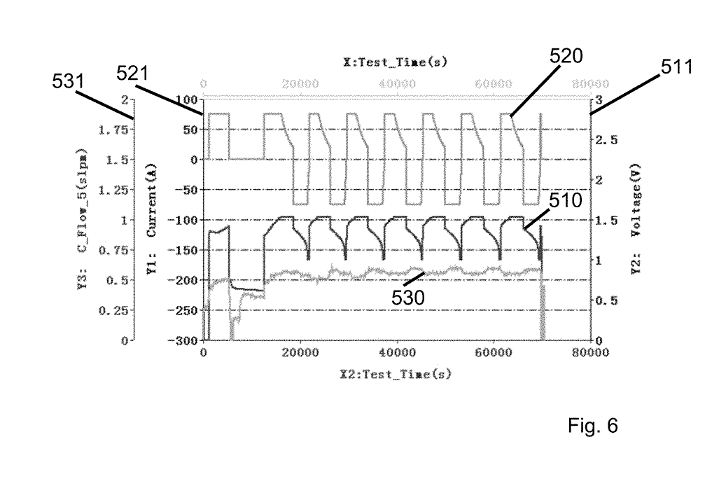

The flow battery was charged at a rate of 75 A until the state of charge of the posilyte was between 50 and 90% and then a quantity of 30.6 g of liquid glycerol (ACS reagent grade) was added to the posilyte, in which it dissolved. At this point the current was interrupted and the pumps were set to a low rate, this to ensure some degree of agitation in the tanks, see FIG. 6. This condition was maintained for a period of 1 to 2 hours, during which the posilyte was reduced due to the reaction with glycerol. After this period charging was resumed and as the state of charge increased, any unoxidized glycerol reacted, bringing the electrolyte into balance. Balanced in this context means that if the two electrolytes were to be mixed, the final oxidation state of electrolyte in each tank would be 3.5 and the amount of electrolyte in each tank would be identical. This was the desired initial state for the electrolyte at the beginning of cell cycling. This electrolyte would be identical in chemical composition to that prepared in Example 2, which shows that the two methods of electrolyte preparation are essentially equivalent.

FIG. 6 shows voltage, current and flow for a zinc chloride configuration of the flow battery of FIGS. 1-5. Referring to FIG. 6, at a state of charge of about 70% the current 520 is set to 0, shown on axis 521 the flow 530 is reduced, shown by axis 531 and glycerol is added. After a period of two hours, or long enough to react the glycerol, charging is resumed. After charging is completed the electrolyte is in balance, and voltage 510, shown on axis 511, develops as seen with the electrolytes of the other examples.

In summary, the electrolytes of the present configuration, with supporting electrolytes containing zinc and chloride ions, yield improved performance characteristics and ease of preparation in vanadium redox flow batteries. Battery cells utilizing supporting electrolytes containing zinc and chloride ions operate with high vanadium concentrations, superior areal current density, and a wide range of temperature.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. An electrolyte solution for use in a vanadium redox flow cell battery, comprising:
a supporting solution containing chloride ions and zinc ions; and
a battery electrolyte solution containing vanadium ions.

2. The electrolyte solution of claim 1, wherein:
the total concentration of vanadium lies between 2.0 M and 2.75 M in a liquid solution; and
the vanadium is resistant to precipitation of a solid phase from the liquid solution for a duration of at least two weeks at a temperature within the range of −20° C. to +70° C.

3. The electrolyte solution of claim 1 wherein the electrolyte solution is based on an equimolar mixture of V³+ and V⁴+ ions.

4. The electrolyte solution of claim 1 wherein the electrolyte solution has an initial oxidation state substantially around +3.5.

5. The electrolyte solution of claim 1 wherein the electrolyte solution defines V⁴⁺ as an electroactive species prior to charging or discharging.

6. The electrolyte solution of claim 5 wherein species of vanadium other than V⁴⁺ are excluded from the electrolyte solution.

7. The electrolyte solution of claim 5 wherein the electrolyte solution is obtained by the reduction of V⁵⁺ by oxalic acid.

8. The solution of claim 5 wherein the electrolyte solution is obtained by the reduction of V⁵⁺ by glycerol.

9. The solution of claim 1 wherein the electrolyte solution defines V⁴⁺ as an electroactive species prior to charging or discharging, wherein an oxidation state defined by a substantially equimolar mixture of V³⁺ and V⁴⁺ ions results from zinc metal as a further reducing agent.

10. The solution of claim 1 wherein the electrolyte solution defines V⁴⁺ as an electroactive species prior to charging or discharging, wherein an oxidation state defined by a substantially equimolar mixture of V³⁺ and V⁴⁺ ions results from charging of a battery cell containing the electrolyte solution in both a positive and negative tank, followed by reduction of a posilyte in the positive tank by the use of glycerol or oxalic acid.

11. A positive half cell electrolyte solution for use in a vanadium redox flow cell battery, comprising:
chloride ions and zinc ions; and
vanadium defined by an oxidation state of V⁴⁺ ions and V⁵⁺ ions.

12. The electrolyte solution of claim 11, wherein a total concentration of the vanadium is in a range between 0.5 M and 3.0 M.

13. The electrolyte solution of claim 11 wherein the electrolyte solution is responsive to a charge current in a battery cell by losing electrons to achieve an oxidation state up to +5.0.

14. A negative half-cell electrolyte solution for use in a vanadium redox flow cell battery, comprising:
chloride ions and zinc ions; and
vanadium defined by an oxidation state of V²⁺ and V³⁺ ions.

15. The electrolyte solution of claim 14, wherein a total concentration of the vanadium is in a range between 0.5 M and 3.0 M.

16. The electrolyte solution of claim 14 wherein the electrolyte is responsive to a charge current in a battery cell by gaining electrons to achieve an oxidation state of down to +2.0.

17. A method for generating an electrolyte for a redox flow battery, comprising:
depositing a known weight of V₂O₅ into a preparation vessel;
mixing aqueous hydrochloric acid into the preparation vessel to form a slurry;
adding an organic reducing agent to the slurry;
mixing the slurry until dissolution of the V₂O₅;
after a cooling period, adding zinc metal and agitating until dissolution.

18. The method of claim 17 wherein adding the organic reducing agent further comprises:
adding oxalic acid, or glycerol to the slurry to achieve a vanadium oxidation state of substantially around 4.0+; and
adding the zinc based substance further comprises adding solid zinc or zinc salt to bring the vanadium oxidation state to substantially around 3.5+.
